(19) United States
(12) Patent Application Publication
(10) Pub. No.: US 2026/0300075 A1
(43) Pub. Date: Oct. 1, 2026

(54) METHOD AND SYSTEM FOR PERFORMING ROOT CAUSE ANALYSIS IN INFORMATION TECHNOLOGY INFRASTRUCTURE

(71) Applicant: HCL Technologies Limited, New Delhi (IN)

(72) Inventors: Navin Sabharwal, Delhi (IN); Punith Krishnamurthy, Bangalore (IN)

(21) Appl. No.: 19/457,193

(22) Filed: Jan. 23, 2026

(30) Foreign Application Priority Data
Mar. 31, 2025 (IN) 202511031862

(51) Int. Cl. G06F 11/07

(52) U.S. Cl. CPC G06F 11/079

(57) ABSTRACT

A system and method for performing root cause analysis in an information technology (IT) infrastructure is disclosed. A processor receives, in a predefined time duration, a plurality of events and an associated event data corresponding to one or more set of entities of the IT infrastructure. One or more sets of group-events is determined based on determination of a semantic relationship between each of the plurality of events. For each of the one or more sets of group events, a topology graph is determined based on a determination of a weighted temporal relationship between each group event of a corresponding set of group events. A root cause of a corresponding issue of the corresponding set of group events is determined based on the topology graph.

### TECHNICAL FIELD

This disclosure relates generally to the field of the Information Technology (IT) service management and particularly relates to method and system for performing root cause analysis in an IT infrastructure.

### BACKGROUND

Information Technology (IT) infrastructure may include various interconnected entities such as systems, services, and devices. These components may be interconnected or interdependent with respect to shared resources etc. Due to this, any issue in one component may lead to functional issues in other dependent components. Understanding the relationships between these entities is crucial for effective infrastructure management, root cause analysis (RCA), and incident resolution. The ability to dynamically map dependencies between these entities helps organizations minimize downtime, optimize resource utilization, and enhance overall system reliability.

Existing systems rely on manual intervention, where subject matter experts define relationship between entities based on past experiences and static configurations in IT service Management (ITSM) systems. However, these manual methods may be prone to errors due to the dynamic nature of IT environments, where frequence changes in configurations, software updates, infrastructure modifications make it difficult to maintain up-to-date relationship information. Additionally, the volume of generated events corresponding to the entities leads to redundancy and false positives, further complicates root cause analysis, As a result, IT teams spend excessive time and effort in correlating alerts and identifying dependencies between the events.

Thus, there is a requirement to perform root cause analysis in the IT infrastructure.

### SUMMARY OF THE INVENTION

In an embodiment, a method for performing root cause analysis in an information technology (IT) infrastructure is disclosed. The method may include receiving, by a processor and in a predefined time duration, a plurality of events and an associated event data corresponding to one or more set of entities of the IT infrastructure. In an embodiment, the associated event data each of the plurality of events may include semantic information and temporal information. The method may further include determining, by the processor, one or more sets of group events based on determination of a semantic relationship between each of the plurality of events. In an embodiment, each set of group events from the one or more sets of group events may correspond to an issue in the IT infrastructure. In an embodiment, the semantic relationship between each of the plurality of events may be determined based on a comparison of corresponding semantic information of each of the plurality of events. The method may further include, determining, by the processor and for each of the one or more sets of group events, a topology graph based on a determination of a weighted temporal relationship between each group event of a corresponding set of group events. In an embodiment, the weighted temporal relationship may be determined based on corresponding temporal information of each group event of the corresponding set of group events. In an embodiment, the topology graph may include at least two nodes representing the one or more set of entities associated with the corresponding set of group events. In an embodiment, the topology graph may also include an edge connecting the at least two nodes. In an embodiment, the edge may represent a corresponding weighted temporal relationship between the at least two nodes. The method may further include determining, by the processor and for each of the one or more sets of group events, a root cause of a corresponding issue of the corresponding set of group events based on the topology graph.

In an embodiment, a system for performing root cause analysis in an information technology (IT) infrastructure is disclosed. The system may include a processor, and a memory communicatively coupled to the processor. In an embodiment, the memory stores processor-executable instructions, which when executed by the processor, cause the processor to receive, in a predefined time duration, a plurality of events and an associated event data corresponding to one or more set of entities of the IT infrastructure. In an embodiment, the associated event data each of the plurality of events may include semantic information and temporal information. The processor may further determine one or more sets of group events based on determination of a semantic relationship between each of the plurality of events. In an embodiment, each set of group events from the one or more sets of group events may correspond to an issue in the IT infrastructure. In an embodiment, the semantic relationship between each of the plurality of events may be determined based on a comparison of corresponding semantic information of each of the plurality of events. The processor may further determine and for each of the one or more sets of group events, a topology graph based on a determination of a weighted temporal relationship between each group event of a corresponding set of group events. In an embodiment, the weighted temporal relationship may be determined based on corresponding temporal information of each group event of the corresponding set of group events. In an embodiment, the topology graph may include at least two nodes representing the one or more set of entities associated with the corresponding set of group events. In an embodiment, the topology graph may also include an edge connecting the at least two nodes. In an embodiment, the edge may represent a corresponding weighted temporal relationship between the at least two nodes. The processor may further determine and for each of the one or more sets of group events, a root cause of a corresponding issue of the corresponding set of group events based on the topology graph.

### BRIEF DESCRIPTION OF THE DRAWINGS

The accompanying drawings, which are incorporated in and constitute a part of this disclosure, illustrate exemplary embodiments and, together with the description, explain the disclosed principles.

FIG. 1 is a block diagram of an exemplary system for performing root cause analysis in an information technology (IT) infrastructure, in accordance with an embodiment of the present disclosure.

FIG. 2 is a block diagram of various modules within the memory of the computing device configured to perform root cause analysis in an IT infrastructure, in accordance with an embodiment of the present disclosure.

FIG. 3 illustrates an exemplary first topology graph, in accordance with an embodiment of the present disclosure.

FIG. 4 illustrates an exemplary second topology graph, in accordance with an embodiment of the present disclosure.

FIG. 5 illustrates an exemplary third topology graph, in accordance with an embodiment of the present disclosure.

FIG. 6 is a flow diagram of a methodology to perform root cause analysis in an IT infrastructure, in accordance with an embodiment of the present disclosure.

FIG. 7 is a flow diagram of an exemplary methodology to determine a weighted temporal relationship between each group event of a corresponding set of group events, in accordance with an embodiment of the present disclosure.

FIG. 8 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the scope of the disclosed embodiments. It is intended that the following detailed description be considered exemplary only, with the true scope being indicated by the following claims. Additional illustrative embodiments are listed.

Further, the phrases “in some embodiments”, “in accordance with some embodiments”, “in the embodiments shown”, “in other embodiments”, and the like mean a particular feature, structure, or characteristic following the phrase is included in at least one embodiment of the present disclosure and may be included in more than one embodiment. In addition, such phrases do not necessarily refer to the same embodiments or different embodiments. It is intended that the following detailed description be considered exemplary only, with the true scope being indicated by the following claims.

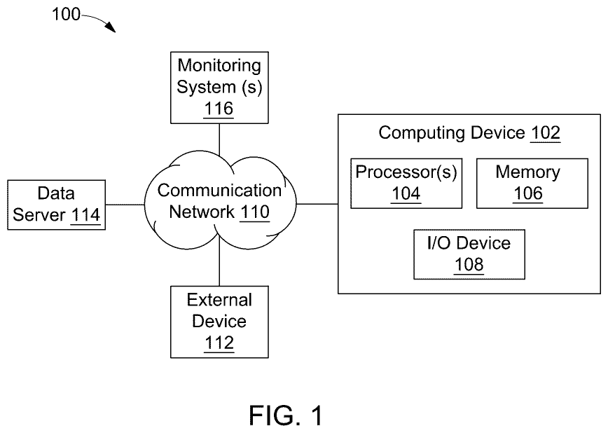

Referring now to FIG. 1, an exemplary system 100 for performing root cause analysis in an information technology (IT) infrastructure, is illustrated, in accordance with an embodiment of the present disclosure. In an embodiment, the IT infrastructure may be implemented across various industries including information technology, healthcare, retail, finance, manufacturing, and telecommunications. In an embodiment, the IT infrastructure may include a set of entities, including but not limited to servers, databases, network devices, cloud computing resources, storage systems, and services. The system 100 may include a computing device 102, an external device 112, a data server 114, monitoring systems 116 communicably coupled to each other through a wired or wireless communication network 110. The computing device 102 may include a processor 104, a memory 106 and an input/output (I/O) device 108.

In an embodiment, examples of processor(s) 104 may include, but are not limited to, an Intel® Itanium® or Itanium 2 processor(s), or AMD® Opteron® or Athlon MP® processor(s), Motorola® lines of processors, Nvidia®, FortiSOC™, system on a chip processors or other future processors.

In an embodiment, the memory 106 may store instructions that, when executed by the processor 104, and cause the processor 104 to perform root cause analysis in an information technology (IT) infrastructure, as will be discussed in greater detail herein below. In an embodiment, the memory 106 may be a non-volatile memory or a volatile memory. In an embodiment, the memory 106 may also store a single module or a combination of different modules to perform root cause analysis in an IT infrastructure. Examples of non-volatile memory may include but are not limited to, a flash memory, a Read Only Memory (ROM), a Programmable ROM (PROM), Erasable PROM (EPROM), and Electrically EPROM (EEPROM) memory. Further, examples of volatile memory may include but are not limited to, Dynamic Random Access Memory (DRAM), and Static Random-Access memory (SRAM).

In an embodiment, the I/O device 108 may comprise of variety of interface(s), for example, interfaces for data input and output devices, and the like. The I/O device 108 may facilitate inputting of instructions by a user communicating with the computing device 102. In an embodiment, the I/O device 108 may be wirelessly connected to the computing device 102 through wireless network interfaces such as Bluetooth®, infrared, or any other wireless radio communication known in the art. In an embodiment, the I/O device 108 may be connected to a communication pathway for one or more components of the computing device 102 to facilitate the transmission of inputted instructions and output results of data generated by various components such as, but not limited to, processor(s) 104 and memory 106.

In an embodiment, the data server 114 may be enabled in a remote cloud server or a co-located server and may include a database (not shown) to store a plurality of events, semantic information, temporal information, weighted temporal relationship, vector representation, topology graph, and any other data necessary for the system 100 to perform root cause analysis in the IT infrastructure. In an embodiment, the data server 114 may store data input by the external device 112 or output generated by the computing device 102. In an embodiment, the computing device 102 may be communicatively coupled with the data server 114 through the communication network 110.

In an embodiment, the communication network 110 may be a wired or a wireless network or a combination thereof. The communication network 110 can be implemented as one of the different types of networks, such as but not limited to, ethernet IP network, intranet, local area network (LAN), wide area network (WAN), or a Metropolitan Area Network (MAN). Various devices in the system 100 may be configured to connect to the communication network 110, in accordance with various wired and wireless communication protocols. Examples of such wired and wireless communication protocols may include, but are not limited to, a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols. Further the communication network 110 can include a variety of network devices, including routers, bridges, servers, computing devices, storage devices, and the like.

In an embodiment, the computing device 102 may receive a plurality of inputs from the external device 112 through the communication network 110. In an embodiment, the computing device 102 and the external device 112 may be a computing system, including but not limited to, a laptop computer, a desktop computer, a notebook, a workstation, a server, a portable computer, a handheld or a mobile device. In an embodiment, the computing device 102 may be, but not limited to, in-built into the external device 112 or may be a standalone computing device.

In an embodiment, the monitoring systems 116 may include various hardware and software components configured to continuously track, analyse, and report events within the IT infrastructure. The monitoring systems 116 may include, but are not limited to, network monitoring tools, application performance monitoring (APM) systems, security information and event management (SIEM) solutions, infrastructure monitoring tools, and log management systems. These systems may be deployed across different layers of the IT infrastructure, including servers, databases, cloud resources, network devices, and application services. The monitoring systems 116 may collect a plurality of events and an associated event data corresponding to the set of entities of the IP infrastructure.

Further, the computing device 102 may perform various functions in order to perform root cause analysis in the IT infrastructure. By way of an example, the computing device 102, in a predefined time duration, may receive a plurality of events and an associated event data corresponding to the set of entities of the IT infrastructure, as an input. It should be noted that the input may be received from the monitoring systems 116. In an embodiment, the plurality of events received from the monitoring systems 116 may include various types of notifications, alerts, logs, and metric-based observations that indicate the state, performance, and security of the set of entities within the IT infrastructure. These events may originate from the set of entities such as servers, databases, cloud resources, network devices, storage systems, and services within the IT infrastructure and may provide insights into both normal operations and abnormal conditions within the IT infrastructure. Each of these plurality of events may be accompanied by an associated event data. The associated event data may include semantic information and temporal information. The semantic information may include, but are not limited to, event parameters (i.e., event source, event severity, event type, entity identifier, user information, process or transaction ID, and configuration data), event title, and event description. The temporal information may include, but is not limited to, time of occurrence of a corresponding event (i.e., event timestamp).

Further, the computing device 102 may pre-process the semantic information by using one or more of pre-processing techniques. The pre-processing techniques may include, but are not limited to, stemming techniques, lemmatization techniques, filtering techniques, masking techniques and like. The computing device 102 may further convert the pre-processed semantic information into vector representations using a Large Language Model (LLM). In an embodiment, the LLM may be trained on contextual information associated with one or more domains to determine the vector representations. The computing device 102 may further store the vector representations and the corresponding pre-processed semantic information in the database within the data server 114.

The computing device 102 may further determine one or more sets of group events based on determination of a semantic relationship between each of the plurality of events. In an embodiment, each set of group events from the one or more sets of group events correspond to an issue in the IT infrastructure. In an embodiment, the semantic relationship between each of the plurality of events may be determined based on a comparison of corresponding semantic information of each of the plurality of events. In an embodiment, the comparison of the corresponding semantic information of each of the plurality of events may be based on a result of a comparison of the vector representations of each of the plurality of events. In an embodiment, the result of comparison may include a similarity score. In an embodiment, the semantic relationship between each of the plurality of events may be determined when the similarity score exceeds a predefined threshold.

The computing device 102 may further determine a topology graph for each of the one or more sets of group events. The computing device 102, in order to determine the topology graph for each of the one or more sets of group events, may determine a weighted temporal relationship between each group event of a corresponding set of group events. In an embodiment, the topology graph may include at least two nodes representing the one or more set of entities associated with the corresponding set of group events. Moreover, the topology graph may include an edge connecting the at least two nodes. In an embodiment, the edge represents a corresponding weighted temporal relationship between the at least two nodes. In an embodiment, one of the at least two nodes is determined as a causal node and remaining of the at least two nodes are determined as impacted nodes.

The computing device 102, in order to determine the weighted temporal relationship, may determine a temporal relationship between each of the corresponding set of group events based on analysis of the corresponding temporal information to determine a temporal sequence. The computing device 102, in order to determine the weighted temporal relationship, may further determine a correlational weight of each temporal relationship between each of the corresponding set of group events based on a frequency of each temporal relationship. Thereafter, the computing device 102, for each of the one or more sets of group events, may determine a root cause of a corresponding issue of the corresponding set of group events based on the topology graph.

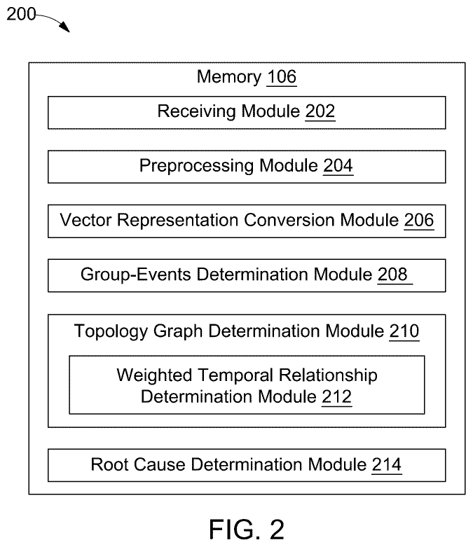

Referring now to FIG. 2, a block diagram 200 of various modules within the memory 106 of the computing device 102 configured to perform root cause analysis in an IT infrastructure is illustrated, in accordance with an embodiment of the present disclosure. FIG. 2 is explained in conjunction with FIG. 1. The memory 106 may include a receiving module 202, a preprocessing module 204, a vector representation conversion module 206, a group events determination module 208, a topology graph determination module 210, a root cause determination module 214.

The receiving module 202, in a predefined time duration, may receive a plurality of events and an associated event data corresponding to one or more set of entities of the IT infrastructure. It should be noted that the input may be received from the monitoring systems 116. In an embodiment, the plurality of events and the associated event data may be received in near real time from the monitoring systems 116. In an embodiment, the plurality of events received from the monitoring systems 116 may include various types of notifications, alerts, logs, and metric-based observations that indicate the state, performance, and security of the set of entities within the IT infrastructure. These events may originate from the set of entities such as servers, databases, cloud resources, network devices, storage systems, and services within the IT infrastructure and may provide insights into both normal operations and abnormal conditions within the IT infrastructure. Each of these plurality of events may be accompanied by an associated event data. In an embodiment, the associated event data may include semantic information and temporal information. The semantic information may include, but are not limited to, event parameters (i.e., event source, event severity, event type, entity identifier, user information, process or transaction ID, and configuration data), event title, and event description. The temporal information may include, but is not limited to, time of occurrence of a corresponding event (i.e., event timestamp).

The preprocessing module 204 may pre-process the semantic information by using one or more of pre-processing techniques. The pre-processing techniques may include, but are not limited to, stemming techniques, lemmatization techniques, filtering techniques, and masking techniques. In an embodiment, the preprocessing techniques employed by the preprocessing module 204 may include, but are not limited to, stemming techniques, lemmatization techniques, filtering techniques, and masking techniques. The stemming techniques involve reducing words in the event description of the plurality of events to their base or root form by removing suffixes and prefixes. For example, the words “monitoring,” “monitored,” and “monitor” may be reduced to their common root form, “monitor,” to standardize the event description. The lemmatization techniques further analyse the context of the words of the event description and convert them into their canonical form (lemma). For example, the words “better” and “good” may be converted to a common lemma, “good” to ensure that semantically related words are treated as equivalent. The filtering techniques are employed to remove irrelevant or redundant information from the event description, such as common stop words (e.g., “and,” “the,” “is”), special characters, or noise that does not contribute to the event's meaning. The masking techniques are applied to replace sensitive or variable information, such as IP addresses, hostnames, or user-specific details, with generalized placeholders. For example, an IP address “192.168.1.1” may be masked as “IP_ADDRESS” or a hostname “server123” may be replaced with “SERVER_NAME.”

The vector representation conversion module 206 may convert the pre-processed semantic information into vector representations using a Large Language Model (LLM). In an embodiment, the LLM may be trained on contextual information associated with one or more domains to determine the vector representations. It should be noted that the domains may be but not limited to Information Technology, Healthcare and Retail. Examples of the LLM may be, but may not be limited to, Generative Pre-trained Transformer (GPT)-3, GPT-3.5, GPT-4, Language Model for Dialogue Applications (LaMDA), Pathways Language Model (PaLM), Gemini, Claude, BigScience Large Open-science Open-access Multilingual Language Model (BLOOM), Large Language Model Meta AI (Llama), Mistral 7B, Mixtral 8x7B, Mixtral 8x22B, or the like. Further, the vector representation conversion module 206 may store the vector representations and the corresponding pre-processed semantic information in the database within the data server 114.

The group events determination module 208 may determine one or more sets of group-events based on determination of a semantic relationship between each of the plurality of events. In an embodiment, the semantic relationship between each of the plurality of events may be determined based on a comparison of corresponding semantic information of each of the plurality of events. In an embodiment, each set of group events from the one or more sets of group events correspond to an issue in the IT infrastructure. In an embodiment, the semantic relationship between each of the plurality of events may be determined based on a comparison of corresponding semantic information of each of the plurality of events. In an embodiment, the comparison of the corresponding semantic information of each of the plurality of events may be based on a result of a comparison of the vector representations of each of the plurality of events. In an embodiment, the result of comparison may include a similarity score. In an embodiment, the semantic relationship between each of the plurality of evens may be determined when the similarity score exceeds a predefined threshold. In an embodiment, the predefined threshold value may be configured based on factors such as system requirements, event types, or domain-specific criteria. For example, consider a scenario where multiple events related to high CPU utilization on a server are received:
“Event 1: CPU utilization high on server Server A at time t
Event 2: Load is high on Server A at time t+2
Event 3: CPU utilization high on server Server A at time t+3
Event n: Load is high on Server A at time T+n”

In this case, since all events originate from the same entity (Server A) and describe the same issue (high CPU usage), their vector representations will yield a high similarity score, exceeding the threshold. As a result, the module will group these events into a single set of group events and generate an aggregated alert indicating “CPU utilization high on server Server A.” This aggregation reduces redundancy by merging duplicate events into a single actionable alert, simplifying further analysis. In this example, multiple events are generated over time, all referring to the same entity (Server A) and describing the same issue (high CPU utilization). As these events are reported at different times (e.g., t, t+2, t+3), they may initially appear as independent events within the IT infrastructure. However, upon further analysis, the system identifies that they are repeated notifications of the same problem. Instead of treating each event as a separate alert, the group events determination module 208 may deduplicate and aggregate them into one unified alert.

In another example, the group events determination module 208 can handle cases where event descriptions differ but refer to the same underlying issue. For instance:
“Event 1: CPU utilization high on server Server A at time t
Event 2: Load is high on Server A at time t+2
Event 3: CPU utilization high on server Server A at time t+3
Event n: Load is high on server A at time T+n”

In this example, the events come from the same entity (Server A) but have slightly different descriptions. Event 1 and Event 3 explicitly mention “CPU utilization high,” while Event 2 uses a different phrasing: “Load is high on Server A.” Although the descriptions differ, these events refer to the same underlying problem such as high resource consumption (CPU or overall load) on the server. The group events determination module 208 may successfully deduplicate events with different descriptions but similar meanings.

The topology graph determination module 210 may determine a topology graph for each of the one or more sets of group events based on a determination of a weighted temporal relationship between each group event of a corresponding set of group events. In an embodiment, the topology graph may include at least two nodes representing the one or more set of entities associated with the corresponding set of group events. Moreover, the topology graph may include an edge connecting the at least two nodes. In an embodiment, the edge represents a corresponding weighted temporal relationship between the at least two nodes. In an embodiment, one of the at least two nodes is determined as a causal node and remaining of the at least two nodes are determined as impacted nodes.

The topology graph determination module 210 may include a weighted temporal relationship determination module 212. The weighted temporal relationship determination module 212, in order to determine the weighted temporal relationship, may determine a temporal relationship between each of the corresponding sets of group events based on analysis of the corresponding temporal information to determine a temporal sequence. The weighted temporal relationship determination module 212, in order to determine the weighted temporal relationship, may further determine a correlational weight of each temporal relationship between each of the corresponding set of group events based on a frequency of each temporal relationship.

The root cause determination module 214, for each of the one or more sets of group events, may determine a root cause of a corresponding issue of the corresponding set of group events based on the topology graph. In an embodiment, the root cause determination module 214 may evaluate causal chains, starting from nodes identified as potential causes and tracing their impact on downstream nodes through weighted edges. A node with the highest causal impact and temporal precedence is determined as the causal node, representing the root cause of the issue. For example, Event 1: CPU utilization high on server A consistently triggers downstream impacts such as Event 2: network congestion on server B and Event 3: memory issues on server C, the system will identify Event 1 as the root cause.

An example of this can be observed when the computing device 102 receives multiple events from monitoring systems 116 at different points in time. These events represent performance-related issues across various servers or devices:
Event 1: CPU utilization high on Server A at time t
Event 2: CPU utilization high on Server B at time t+2
Event 3: Memory utilization high on Server C at time t+3
Event n: Network utilization high on Server D at time t+n

The topology graph determination module 210 may construct a topology graph using nodes and edges. Nodes represent entities and their associated parameters (e.g., Server A, Server B, Server C, and Server D, along with CPU, memory, and network parameters). Edges represent the temporal relationships between the nodes, with weights reflecting the strength of the dependency. The weighted temporal relationships determination module 212 may analyse the order and frequency of events to assign appropriate weights to the edges. For example, the edge from Server A (CPU utilization) to Server B (CPU utilization) may have a weight based on how often high CPU usage on Server A precedes or correlates with a similar issue on Server B. Similarly, edges to Server C (memory utilization) and Server D (network utilization) represent cascading impacts which indicates that the issue on Server A propagates through the IT infrastructure. Further, the root cause determination module 214 may analyse the topology graph to trace dependencies and identify the causal node. The causal node may be determined by evaluating the temporal sequence and correlational weighs. In this example, Event 1 (CPU utilization on Server A may be identified as the causal node because it occurs first and consistently leads to downstream impacts on other entities. Event 2 (CPU utilization high on Server B), Event 3 (memory utilization high on Server C), and Event n (network utilization high on Server D) may be identified as impacted nodes because they follow Event 1 and have strong temporal and correlational dependencies with it. Once the root cause determination module 214 may identified the root cause and its downstream impacts, the module 214 may aggregate the related events into a single actionable alert. For example, the aggregated alert of the root cause may be “Utilization issue with application App12.”

In an exemplary scenario, let's assume App12 is an e-commerce platform with architecture, Server A as web server (handles incoming traffic and serves dynamic content), Server B as application server )processes business logic), Server C as Caching server (Stores frequently accessed data), Server D as Network proxy or database server. When Server A experiences high CPU utilization. Server A starts delaying incoming requests, which overloads Server B as it tries to handle a queue of pending tasks. The delayed responses lead to excessive memory usage on Server C, as it struggles to cache incomplete or unprocessed data. Server D experiences high network traffic as multiple retries or retries to fetch data from the database increase due to pending responses. This cascading failure across the components supporting App12 leads the computing device 102 to generate the application-level alert.

It should be noted that all such aforementioned modules 202-214 may be represented as a single module or a combination of different modules. Further, as will be appreciated by those skilled in the art, each of the modules 202-214 may reside, in whole or in parts, on one device or multiple devices in communication with each other. In some embodiments, each of the modules 202-214 may be implemented as dedicated hardware circuit comprising custom application-specific integrated circuit (ASIC) or gate arrays, off-the-shelf semiconductors such as logic chips, transistors, or other discrete components. Each of the modules 202-214 may also be implemented in a programmable hardware device such as a field programmable gate array (FGPA), programmable array logic, programmable logic device, and so forth. Alternatively, each of the modules 202-214 may be implemented in software for execution by various types of processors (e.g. processor 104). An identified module of executable code may, for instance, include one or more physical or logical blocks of computer instructions, which may, for instance, be organized as an object, procedure, function, or other construct. Nevertheless, the executables of an identified module or component need not be physically located together but may include disparate instructions stored in different locations which, when joined logically together, include the module and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for performing root cause analysis in an information technology (IT) infrastructure. For example, the exemplary system 100 and the associated computing device 102 may perform root cause analysis in an IT infrastructure by the processes discussed herein. In particular, as will be appreciated by those of ordinary skill in the art, control logic and/or automated routines for performing the techniques and steps described herein may be implemented by the system 100 and the associated computing device 102 either by hardware, software, or combinations of hardware and software. For example, suitable code may be accessed and executed by the one or more processors on the system 100 to perform some or all of the techniques described herein. Similarly, application specific integrated circuits (ASICs) configured to perform some, or all of the processes described herein may be included in the one or more processors on the system 100.

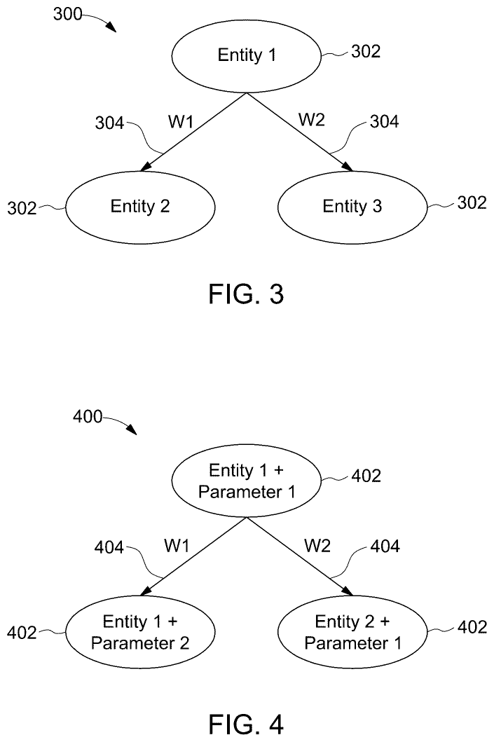

Referring now to FIG. 3, an exemplary first topology graph 300, is illustrated, in accordance with an embodiment of the present disclosure. FIG. 3 is explained in conjunction with the FIG. 2. In FIG. 3, the topology graph 300A depicts a set of nodes 302 and edges 304, wherein each node 302 represents an entity within the IT infrastructure, and each edge 304 represents a temporal relationship between the entities. The first topology graph 300 may be constructed after the group-events determination module 208 may determine the one or more sets of group events and analyses the corresponding temporal and semantic relationships among them. The nodes 302 in the first temporal graph 300 may represent entities such as servers, network devices, databases, or cloud services, each of which is associated with one or more events, as identified by the monitoring systems 116 within the IT infrastructure.

For example, Entity 1 could represent a primary server or application where an initial event, such as a CPU utilization spike, is detected. Entity 2 and Entity 3 represent other components that may be affected by this initial event, such as a dependent service or database. The nodes in the topology graph 300A represent individual entities within the IT infrastructure, such as servers, databases, or cloud services. For example, Entity 1, Entity 2, and Entity 3 each represent a distinct entity without explicitly specifying any associated event parameters. These entities are connected through edges 304, denoted by W1 and W2, which represent the strength or weight of the temporal relationships between the entities. The weights W1 and W2 quantify the correlational dependency based on the frequency and order of events occurring between the entities within a predefined time window. In this embodiment, the topology graph determination module 210 analyses the temporal information of the events to construct edges between the nodes. The topology graph determination module 210 may utilize the weighted temporal relationship determination module 212 to establish the order and frequency of events, thereby assigning appropriate weights to the edges. For instance, if events originating from Entity 1 frequently precede events at Entity 2 within a short time frame, the weight W1 will increase, indicating a strong temporal dependency. Similarly, the weight W2 is determined based on the correlational strength between Entity 1 and Entity 3. In practice, the first topology graph 300 helps identify the causal and impacted nodes within the IT infrastructure. For example, Entity 1 may be determined as the causal node because it triggers events that propagate to downstream entities, represented by Entity 2 and Entity 3, which are identified as impacted nodes. By analyzing the direction and strength of the edges, the computing device 102 may conclude that a failure or anomaly at Entity 1 is likely the root cause of the issues affecting the other entities. This information is crucial for generating root cause analysis (RCA) reports, which map causal events to impacted events and assist in incident resolution.

Referring now to FIG. 4, an exemplary second topology graph 400, is illustrated, in accordance with an embodiment of the present disclosure. FIG. 4 is explained in conjunction with the FIG. 2. The topology graph 400 represents a structure of interconnected nodes and edges that reflect the relationships between entities and the parameters associated with them. The nodes, labelled 402, correspond to entities within the IT infrastructure. Each entity may represent a component in the IT infrastructure, such as a server, database, network device, cloud resource, or application service. Additionally, the nodes 402 may include specific parameters (e.g., CPU usage, memory consumption) that may be associated with the events detected within the IT infrastructure. For instance, Entity 1+Parameter 1 may represent a server experiencing a high CPU usage event. The nodes in the topology graph 400 represent a combination of entities and their associated parameters. For example, Entity 1+Parameter 1 and Entity 2+Parameter 1 specify not only the entity involved but also the type of event or issue (such as CPU usage, memory consumption, or disk I/O) being tracked. The edges 404 may connect the nodes 402 in the second topology graph 400 between the entities. The weights, denoted as W1 and W2 may quantify the strength of the temporal dependencies based on the frequency and order of events occurring between the corresponding entities.

In the illustrated example, W1 represents the relationship between Entity+Parameter 1 and Entity 1+Parameter 2, while W2 represents the relationship between Entity 1+Parameter 1 and Entity 2+Parameter 1. The weights may be determined by analyzing the occurrence patterns and temporal sequences of related events. In operation, the topology graph determination module 210 may construct the second topology graph 400 by first grouping related events using their semantic relationships and then analyzing their temporal information to establish dependencies between the entities. The weighted temporal relationship determination module 212 may evaluate the sequence and frequency of events to compute the weights for the edges 404. For example, if an event corresponding to Entity 1 +Parameter 1 frequently precedes an event at Entity 2+Parameter 1, the weight W2 may increase which indicates a strong causal relationship between the two entities.

The second topology graph 400 is essential for identifying causal nodes and impacted nodes within the IT infrastructure. In this embodiment, Entity 1+Parameter 1 may be identified as the causal node, triggering events that propagate to Entity 1+Parameter 2 and Entity 2+Parameter 1, which may be determined as impacted nodes. The direction and strength of the edges 404 may provide insights for identifying the origin of issues and their impact on other components in the infrastructure.

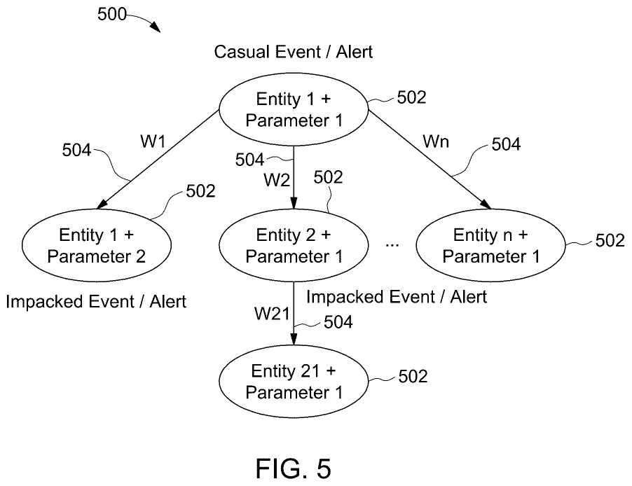

Referring now to FIG. 5, an exemplary third topology graph 500, is illustrated, in accordance with some embodiments of the present disclosure. The FIG. 5 is explained in conjunction with FIG. 2. The nodes, labelled 502, represent entities within the IT infrastructure, such as servers, network devices, cloud resources, and databases, each associated with one or more parameters. For example, Entity 1+Parameter 1 could represent a server experiencing a CPU utilization issue, while Entity 2+Parameter 1 could represent a dependent database service affected by the server's performance degradation. These nodes are connected by edges 504, which signify the weighted temporal relationships between the entities. The weights, labelled W1, W2, and Wn, quantify the strength and frequency of these temporal dependencies based on the sequence and co-occurrence of related events. In this embodiment, Entity 1+Parameter 1 is identified as a causal node, representing the root cause of the issue. Events originating from this node are likely to affect other nodes downstream, such as Entity 2+Parameter 1, Entity 1+Parameter 2, and Entity n+Parameter 1, which are classified as impacted nodes. The topology graph determination module 210 establishes these relationships by analyzing both the temporal and semantic information of the grouped events. The weighted temporal relationship determination module 212 evaluates the temporal sequence of events and computes the edge weights by considering the frequency and order in which events occur between the entities. The edge labelled W1 represents a temporal relationship between Entity 1+Parameter 1 and Entity 1+Parameter 2, indicating that an issue in one parameter (such as high CPU utilization) may lead to a related issue in another parameter (such as high memory usage) within the same entity. Similarly, the edge labelled W2 connects Entity 1+Parameter 1 to Entity 2+Parameter 1, representing a dependency between different entities. The edge Wn extends the causal relationship to Entity n+Parameter 1, indicating that the impact of the root cause may propagate to other services or devices in the infrastructure. Additionally, the edge W21 connects Entity 2+Parameter 1 to Entity 21+Parameter 1, illustrating a cascading effect where an issue affecting one entity can trigger secondary issues in other dependent entities. This propagation of events forms a network of causal and impacted relationships, allowing the system to identify the full scope of the problem and its potential downstream impacts.

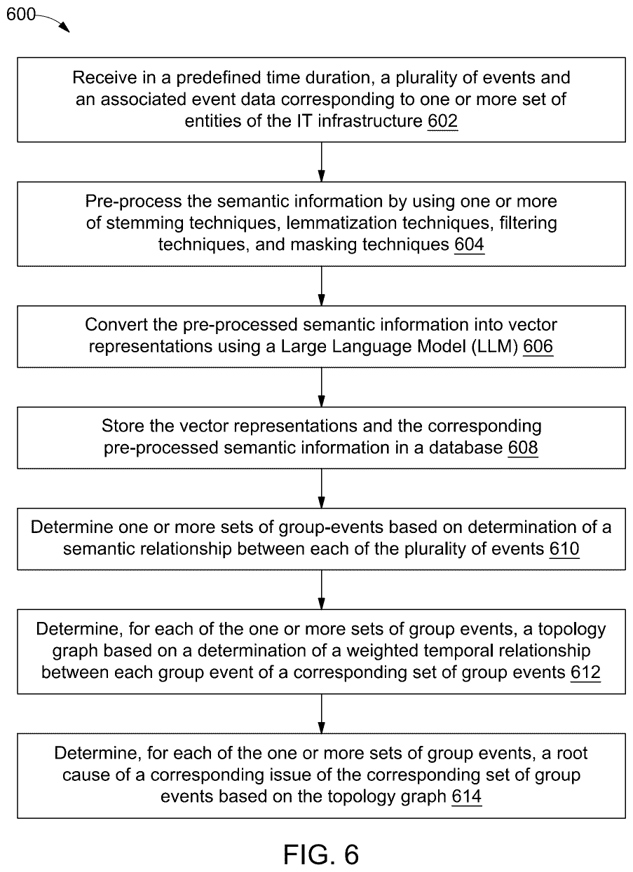

Referring now to FIG. 6, a flow diagram 600 of a methodology to perform root cause analysis in an IT infrastructure is illustrated, in accordance with some embodiments of the present disclosure. FIG. 6 is explained in conjunction with the FIG. 1-2. In an embodiment, the process 600 may include a plurality of steps that may be performed by various modules of the computing device 102 so as to perform root cause analysis in the IT infrastructure.

At step 602, a plurality of events and an associated event data corresponding to one or more set of entities of the IT infrastructure are received in a predefined time duration It should be noted that the input may be received from the monitoring systems 116. In an embodiment, the plurality of events received from the monitoring systems 116 may include various types of notifications, alerts, logs, and metric-based observations that indicate the state, performance, and security of the set of entities within the IT infrastructure. These events may originate from the set of entities such as servers, databases, cloud resources, network devices, storage systems, and services within the IT infrastructure and may provide insights into both normal operations and abnormal conditions within the IT infrastructure. Each of these plurality of events may be accompanied by an associated event data. The associated event data may include semantic information and temporal information. The semantic information may include, but are not limited to, event parameters (i.e., event source, event severity, event type, entity identifier, user information, process or transaction ID, and configuration data), event title, and event description. The temporal information may include, but is not limited to, time of occurrence of a corresponding event (i.e., event timestamp). Further at step 604, the semantic information may be pre-processed by using one or more of stemming techniques, lemmatization techniques, filtering techniques, and masking techniques. Further at step 606, he pre-processed semantic information may be converted into vector representations using a large language model (LLM). In an embodiment, the LLM may be trained on contextual information associated with one or more domains to determine the vector representations.

Further at step 608, the vector representations and the corresponding pre-processed semantic information may be stored in the database within the data server 114. Further at step 610, one or more sets of group-events may be determined based on determination of a semantic relationship between each of the plurality of events. In an embodiment, each set of group events from the one or more sets of group events correspond to an issue in the IT infrastructure. In an embodiment, the semantic relationship between each of the plurality of events may be determined based on a comparison of corresponding semantic information of each of the plurality of events. In an embodiment, the comparison of the corresponding semantic information of each of the plurality of events may be based on a result of a comparison of the vector representations of each of the plurality of events. In an embodiment, the result of comparison may include a similarity score. In an embodiment, the semantic relationship between each of the plurality of events may be determined when the similarity score exceeds a predefined threshold.

Further at step 612, for each of the one or more sets of group events, a topology graph may be determined based on a determination of a weighted temporal relationship between each group event of a corresponding set of group events. In an embodiment, the topology graph may include at least two nodes representing the one or more set of entities associated with the corresponding set of group events. Moreover, the topology graph may include an edge connecting the at least two nodes. In an embodiment, the edge represents a corresponding weighted temporal relationship between the at least two nodes. In an embodiment, one of the at least two nodes may be determined as a causal node and remaining of the at least two nodes are determined as impacted nodes. Further at step 614, for each of the one or more sets of group events, a root cause of a corresponding issue of the corresponding set of group events may be determined based on the topology graph.

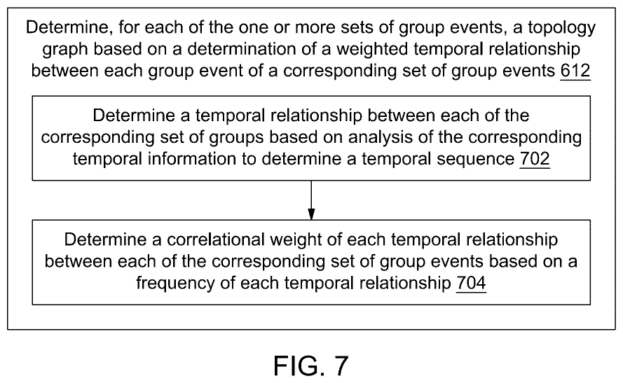

Referring now to FIG. 7, a flow diagram of an exemplary methodology to determine weighted temporal relationship between each group event of a corresponding set of group events, is illustrated, in accordance with some embodiment of the present disclosure. FIG. 7 is explained in conjunction with the FIG. 6. At step 702, a temporal relationship between each of the set of group events may be determined based on analysis of the corresponding temporal information to determine a temporal sequence. Further at step 704, a correlational weight of each temporal relationship between each of the corresponding set of group events may be determined based on a frequency of each temporal relationship.

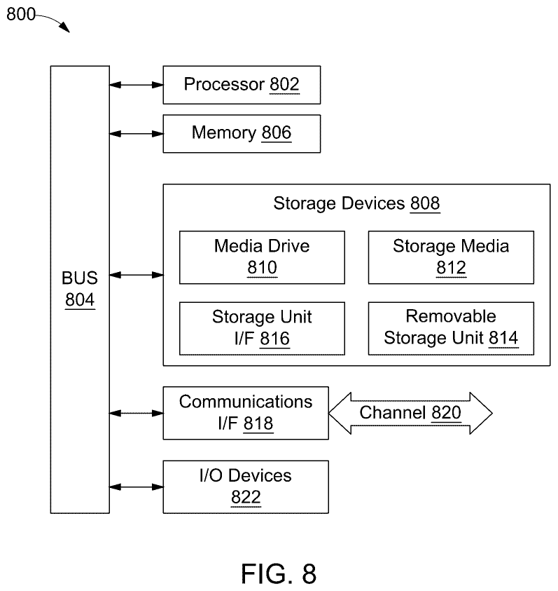

Referring now to FIG. 8, an exemplary computing system 800 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 800 may represent, for example, a user device such as a desktop, a laptop, a mobile phone, personal entertainment device, DVR, and so on, or any other type of special or general-purpose computing device as may be desirable or appropriate for a given application or environment. The computing system 800 may include one or more processors, such as a processor 802 that may be implemented using a general or special purpose processing engine such as, for example, a microprocessor, microcontroller or other control logic. In this example, the processor 802 is connected to a bus 804 or other communication medium. In some embodiments, the processor 802 may be an Artificial Intelligence (AI) processor, which may be implemented as a Tensor Processing Unit (TPU), or a graphical processor unit, or a custom programmable solution Field-Programmable Gate Array (FPGA).

The computing system 800 may also include a memory 806 (main memory), for example, Random Access Memory (RAM) or other dynamic memory, for storing information and instructions to be executed by the processor 802. The memory 806 also may be used for storing temporary variables or other intermediate information during execution of instructions to be executed by the processor 802. The computing system 800 may likewise include a read only memory (“ROM”) or other static storage device coupled to bus 804 for storing static information and instructions for the processor 802.

The computing system 800 may also include a storage device 808, which may include, for example, a media drive 810 and a removable storage interface. The media drive 810 may include a drive or other mechanism to support fixed or removable storage media, such as a hard disk drive, a floppy disk drive, a magnetic tape drive, an SD card port, a USB port, a micro-USB, an optical disk drive, a CD or DVD drive (R or RW), or other removable or fixed media drive. A storage media 812 may include, for example, a hard disk, magnetic tape, flash drive, or other fixed or removable medium that is read by and written to by the media drive 810. As these examples illustrate, the storage media 812 may include a computer-readable storage medium having stored there in particular computer software or data.

In alternative embodiments, the storage devices 808 may include other similar instrumentalities for allowing computer programs or other instructions or data to be loaded into the computing system 800. Such instrumentalities may include, for example, a removable storage unit 814 and a storage unit interface 816, such as a program cartridge and cartridge interface, a removable memory (for example, a flash memory or other removable memory module) and memory slot, and other removable storage units and interfaces that allow software and data to be transferred from the removable storage unit 814 to the computing system 800.

The computing system 800 may also include a communications interface 818. The communications interface 818 may be used to allow software and data to be transferred between the computing system 800 and external devices. Examples of the communications interface 818 may include a network interface (such as an Ethernet or other NIC card), a communications port (such as for example, a USB port, a micro-USB port), Near field Communication (NFC), etc. Software and data transferred via the communications interface 818 are in the form of signals which may be electronic, electromagnetic, optical, or other signals capable of being received by the communications interface 818. These signals are provided to the communications interface 818 via a channel 820. The channel 820 may carry signals and may be implemented using a wireless medium, wire or cable, fiber optics, or other communications medium. Some examples of the channel 820 may include a phone line, a cellular phone link, an RF link, a Bluetooth link, a network interface, a local or wide area network, and other communications channels.

The computing system 800 may further include Input/Output (I/O) devices 822. Examples may include, but are not limited to a display, keypad, microphone, audio speakers, vibrating motor, LED lights, etc. The I/O devices 822 may receive input from a user and also display an output of the computation performed by the processor 802. In this document, the terms “computer program product” and “computer-readable medium” may be used generally to refer to media such as, for example, the memory 806, the storage devices 808, the removable storage unit 814, or signal(s) on the channel 820. These and other forms of computer-readable media may be involved in providing one or more sequences of one or more instructions to the processor 802 for execution. Such instructions, generally referred to as “computer program code” (which may be grouped in the form of computer programs or other groupings), when executed, enable the computing system 800 to perform features or functions of embodiments of the present invention.

In an embodiment where the elements are implemented using software, the software may be stored in a computer-readable medium and loaded into the computing system 800 using, for example, the removable storage unit 814, the media drive 810 or the communications interface 818. The control logic (in this example, software instructions or computer program code), when executed by the processor 802, causes the processor 802 to perform the functions of the invention as described herein.

Thus, the disclosed method 600 and system 100 overcome the challenges associated with managing dynamic and interdependent IT infrastructures by providing an automated approach to determine and maintain up-to-date dependencies between entities, thereby enhancing the efficiency of root cause analysis (RCA) and incident resolution. The disclosed method 600 and system 100 dynamically analyses events in real time and uses semantic and temporal information to construct topology graphs that reflect the relationships between entities. The disclosed method 600 and system 100 accurately identifies causal nodes and downstream impacted nodes based on the sequence and frequency of events, thereby minimizing the reliance on manual intervention and static configurations. The inclusion of semantic comparison using vector representations and the aggregation of semantically related events ensure that redundant and duplicate alerts are deduplicated, reducing false positives and alert fatigue. This automated, real-time approach enables IT teams to minimize downtime, optimize resource allocation, and efficiently identify and resolve issues.

As will be appreciated by those skilled in the art, the techniques described in the various embodiments discussed above are not routine, or conventional, or well-understood in the art. The techniques discussed above provide for performing root cause analysis in information technology infrastructure.

In light of the above-mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem. In addition to perform root cause analysis, the disclosed method and system may also group similar events.

The specification has described a method and system for performing root cause analysis in an IT infrastructure. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, non-volatile memory, hard drives, CD ROMs, DVDs, flash drives, disks, and any other known physical storage media.

As will be also appreciated, the above-described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fibre optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

It is intended that the disclosure and examples be considered as exemplary only, with a true scope and spirit of disclosed embodiments being indicated by the following claims.

What is claimed is:

1. A method for performing root cause analysis in an information technology (IT) infrastructure, the method comprising:
receiving, by a processor and in a predefined time duration, a plurality of events and an associated event data corresponding to one or more set of entities of the IT infrastructure,
wherein the associated event data each of the plurality of events comprises semantic information and temporal information;
determining, by the processor, one or more sets of group-events based on determination of a semantic relationship between each of the plurality of events,
wherein each set of group events from the one or more sets of group events correspond to an issue in the IT infrastructure, and
wherein the semantic relationship between each of the plurality of events is determined based on a comparison of corresponding semantic information of each of the plurality of events;
for each of the one or more sets of group events:
determining, by the processor, a topology graph based on a determination of a weighted temporal relationship between each group event of a corresponding set of group events,
wherein the weighted temporal relationship is determined based on corresponding temporal information of each group event of the corresponding set of group events, and
wherein the topology graph comprises:
at least two nodes representing the one or more set of entities associated with the corresponding set of group events; and
an edge connecting the at least two nodes, wherein the edge represents a corresponding weighted temporal relationship between the at least two nodes; and
determining, by the processor, a root cause of a corresponding issue of the corresponding set of group events based on the topology graph.

2. The method as claimed in claim 1, wherein the semantic information comprises event description, event parameters, and event title, and
wherein the temporal information comprises time of occurrence of a corresponding event.

3. The method as claimed in claim 1, comprising:
pre-processing, by the processor, the semantic information by using one or more of stemming techniques, lemmatization techniques, filtering techniques, and masking techniques.

4. The method as claimed in claim 3, comprising:
converting, by the processor, the pre-processed semantic information into vector representations using a Large Language Model (LLM),
wherein the LLM is trained on contextual information associated with one or more domains to determine the vector representations; and
storing, by the processor, the vector representations and the corresponding pre-processed semantic information in a database.

5. The method as claimed in claim 4, wherein the comparison of the corresponding semantic information of each of the plurality of events is based on a result of a comparison of the vector representations of each of the plurality of events.

6. The method as claimed in claim 1, wherein the determination of the weighted temporal relationship comprises:
determining, by the processor, a temporal relationship between each of the corresponding set of group events based on analysis of the corresponding temporal information to determine a temporal sequence; and
determining, by the processor, a correlational weight of each temporal relationship between each of the corresponding set of group events based on a frequency of each temporal relationship.

7. The method as claimed in claim 1, wherein one of the at least two nodes is determined as a causal node, and remaining of the at least two nodes are determined as impacted nodes, and
wherein the root cause is determined based on the causal node.

8. A system for performing root cause analysis in an information technology (IT) infrastructure, the system comprising:
a processor; and
a memory communicatively coupled to the processor, wherein the memory stores processor-executable instructions, which when executed by the processor, cause the processor to:
receive, in a predefined time duration, a plurality of events and an associated event data corresponding to one or more set of entities of the IT infrastructure,
wherein the associated event data each of the plurality of events comprises semantic information and temporal information;
determine one or more sets of group-events based on determination of a semantic relationship between each of the plurality of events,
wherein each set of group events from the one or more sets of group events correspond to an issue in the IT infrastructure, and
wherein the semantic relationship between each of the plurality of events is determined based on a comparison of corresponding semantic information of each of the plurality of events;
for each of the one or more sets of group events:
determine a topology graph based on a determination of a weighted temporal relationship between each group event of a corresponding set of group events,
wherein the weighted temporal relationship is determined based on corresponding temporal information of each group event of the corresponding set of group events, and
wherein the topology graph comprises:
at least two nodes representing the one or more set of entities associated with the corresponding set of group events; and
an edge connecting the at least two nodes, wherein the edge represents a corresponding weighted temporal relationship between the at least two nodes; and
determine a root cause of a corresponding issue of the corresponding set of group events based on the topology graph.

9. The system as claimed in claim 8, wherein the semantic information comprises event description, event parameters, and event title, and
wherein the temporal information comprises time of occurrence of a corresponding event.

10. The system as claimed in claim 8, wherein the processor-executable instructions, when executed by the processor, cause the processor to:
pre-process the semantic information by using one or more of stemming techniques, lemmatization techniques, filtering techniques, and masking techniques.

11. The system as claimed in claim 10, wherein the processor-executable instructions, when executed by the processor, cause the processor to:
convert the pre-processed semantic information into vector representations using a Large Language Model (LLM),
wherein the LLM is trained on contextual information associated with one or more domains to determine the vector representations; and
store the vector representations and the corresponding pre-processed semantic information in a database.

12. The system as claimed in claim 11, wherein the comparison of the corresponding semantic information of each of the plurality of events is based on a result of a comparison of the vector representations of each of the plurality of events.

13. The system as claimed in claim 8, wherein to determine the weighted temporal relationship, the processor-executable instructions, when executed by the processor, cause the processor to:
determine a temporal relationship between each of the corresponding set of group events based on analysis of the corresponding temporal information to determine a temporal sequence; and
determine a correlational weight of each temporal relationship between each of the corresponding set of group events based on a frequency of each temporal relationship.

14. The system as claimed in claim 8, wherein one of the at least two nodes is determined as a causal node, and remaining of the at least two nodes are determined as impacted nodes, and
wherein the root cause is determined based on the causal node.

15. A non-transitory computer-readable medium storing computer-executable instructions for performing root cause analysis in an Information Technology (IT) infrastructure, the computer-executable instructions configured for:
receiving, by a processor and in a predefined time duration, a plurality of events and an associated event data corresponding to one or more set of entities of the IT infrastructure,
wherein the associated event data each of the plurality of events comprises semantic information and temporal information;
determining, by the processor, one or more sets of group-events based on determination of a semantic relationship between each of the plurality of events,
wherein each set of group events from the one or more sets of group events correspond to an issue in the IT infrastructure, and
wherein the semantic relationship between each of the plurality of events is determined based on a comparison of corresponding semantic information of each of the plurality of events;
for each of the one or more sets of group events:
determining, by the processor, a topology graph based on a determination of a weighted temporal relationship between each group event of a corresponding set of group events,
wherein the weighted temporal relationship is determined based on corresponding temporal information of each group event of the corresponding set of group events, and
wherein the topology graph comprises:
at least two nodes representing the one or more set of entities associated with the corresponding set of group events; and
an edge connecting the at least two nodes, wherein the edge represents a corresponding weighted temporal relationship between the at least two nodes; and
determining, by the processor, a root cause of a corresponding issue of the corresponding set of group events based on the topology graph.

16. The non-transitory computer-readable medium of claim 15, wherein the semantic information comprises event description, event parameters, and event title, and
wherein the temporal information comprises time of occurrence of a corresponding event.

17. The non-transitory computer-readable medium of claim 15, wherein the computer-executable instructions are further configured for:
pre-processing the semantic information by using one or more of stemming techniques, lemmatization techniques, filtering techniques, and masking techniques.

18. The non-transitory computer-readable medium of claim 17, wherein the computer-executable instructions are further configured for:
converting the pre-processed semantic information into vector representations using a Large Language Model (LLM),
wherein the LLM is trained on contextual information associated with one or more domains to determine the vector representations; and
storing the vector representations and the corresponding pre-processed semantic information in a database.

19. The non-transitory computer-readable medium of claim 18, wherein the comparison of the corresponding semantic information of each of the plurality of events is based on a result of a comparison of the vector representations of each of the plurality of events.

20. The non-transitory computer-readable medium of claim 15, wherein for the determination of the weighted temporal relationship, the computer-executable instructions are further configured for:
determining a temporal relationship between each of the corresponding set of group events based on analysis of the corresponding temporal information to determine a temporal sequence; and
determining a correlational weight of each temporal relationship between each of the corresponding set of group events based on a frequency of each temporal relationship.

21. The non-transitory computer-readable medium of claim 15, wherein one of the at least two nodes is determined as a causal node, and remaining of the at least two nodes are determined as impacted nodes, and
wherein the root cause is determined based on the causal node.
